(19) United States
(12) Patent Application Publication
(10) Pub. No.: US 2007/0271180 A1
(43) Pub. Date: Nov. 22, 2007

(54) MULTIMEDIA CONTENT MANAGEMENT SYSTEM AND METHOD OF COUPLING A SENSOR ENABLED MEDIUM TO A NETWORK INFRASTRUCTURE

(76) Inventor: Daniel A. Bochneak, Crystal Lake, IL (US)

Correspondence Address: DANIEL A. BOCHNEAK, 4716 AMY DRIVE, CRYSTAL LAKE, IL, 60014-6347, US

(21) Appl. No.: 11/754,256

(22) Filed: May 25, 2007

Related U.S. Application Data
(60) Provisional application No. 60/803,280, filed on May 26, 2006.

(51) Int. Cl. G06Q 40/00

(52) U.S. Cl. 705/39

(57) ABSTRACT

A Multimedia Content Management System (MCMS) is disclosed for coupling a sensor enabled medium to a network infrastructure. The medium is at least one of a hardcopy medium, such as paper, a device, component or substrate medium. A request for multimedia content is triggered by the interaction with the medium by an end-user interoperating with an associated sensor detection infrastructure, such as a RF reader. The detection infrastructure includes logic for determining if the multimedia content request is local to the end-user, or remote to the end-user. The detection infrastructure is coupled to a multimedia content service provider via network communications.

### CROSS REFERENCE TO RELATED APPLICATION

This application claims priority to U.S. Provisional Patent Application No. 60/803,280 filed May 26, 2006, entitled Multimedia Content Management System (MCMS), which is incorporated herein by reference.

| | |
|---|---|
| Inventor: | Bochneak; Daniel A. (Crystal Lake, IL) |
| Correspondence | Daniel A. Bochneak |
| Name and | 4716 Amy Drive |
| Address: | Crystal Lake |
| | IL |
| | 60014-6347 |
| | US |

### DESCRIPTION

1. Field of the Invention

The invention relates to the integration of components and services. More specifically, the invention relates to a sensor enabled hardcopy medium that communicates with a network infrastructure, resulting in the integration of hardcopy content interactively augmented with multimedia content.

2. Background of the Related Art

Reading with delight has been linked to improving the memory retention of what has been read. Samuel Johnson has been credited with having written in The Idler-essay #74 (Sep. 15, 1759), “What is read with delight is commonly retained, because pleasure always secures attention but the books which are consulted by occasional necessity, and perused with impatience, seldom leave any traces on the mind.”

One of the intents of a multimedia content management system is to address the dynamic components of multimedia learning. Richard E. Mayer, Professor Psychology, University of California has written, “By multimedia we mean that learning material is presented in both words and pictures and may also include sound.”* *Mayer, Richard E. (2005) The Cambridge Handbook of Multimedia Learning, Cambridge University Press.

Multimedia content management systems integrate and coordinate visual and auditory channels, and C. G. Penney is credited in The Cambridge Handbook of Multimedia Learning with having proposed, “Using both the visual and auditory channels, rather than one channel alone, increases the effective working memory capacity.”* *ibid p. 75

A multimedia content management system is intended to support the temporal and topical synchronization of multimedia content, with possible beneficial consequences experienced by an end-user, “People learn more deeply from a multimedia message when corresponding animation and narration are presented simultaneously rather than successively.”* *ibid p. 195

What is needed is a multimedia content management system that interactively augments a hardcopy medium with multimedia content so that the multimedia content is evoked and conveyed to an end-user in near-real-time and with topical synchrony with the hardcopy medium.

### SUMMARY OF THE INVENTION

The present invention relates to an end-user's interaction with hardcopy medium content augmented with multimedia content. The multimedia content is evoked and conveyed to the end-user in near-real-time and topical synchrony.

In accordance with one embodiment of the present invention, a multimedia content management system is disclosed. The system includes a sensor enabled medium; and a sensor detection infrastructure for interacting with the sensor enabled medium, such that when a media content request is transmitted from the medium to the detection infrastructure, a logic controller coupled to the detection infrastructure determines whether the request is local or remote and obtains the requested media content, thus interactively augmenting the medium with the media content.

In accordance with an embodiment of the present invention, the medium can be paper. Alternatively, the medium can be any hardcopy document, substrate, and/or medium. The sensor enabled medium can comprise an RFID device and antennae coupled to the medium. The RFID device can be an RFID tag or transponder.

The medium can facilitate insertion of sensor technology into a lattice matrix of the medium. The medium can also enhance the radio frequency and/or electromagnetic spectrum performance and antennae performance of the RFID device. Nano-scale and/or micro-scale particles can be selectively deposited on and/or in a substrate of the medium. The particles are at least one of the following: zinc, copper, silver, gold, and alloy. Further, RF resonant performance, or Q, can be induced by the particles to enable the associated RF infrastructure to interact with passive sensors/tags and/or RFID transponders. Inkjet technology can also be used to facilitate development of the sensor enabled medium.

In accordance with one embodiment of the present invention, the sensor detection infrastructure is coupled to a binder, wherein the binder is also coupled to the medium. The binder is preferably a physical binder. The binder can include electronic circuitry to support the detection infrastructure. RFID reader technology and sensors can be incorporated into operation of the binder. The binder can also include docking connectors into which is docked portable multimedia devices. The portable multimedia devices include at least one of the following: smart phones, cell phones, Wi-Fi, WiMax, and multimedia players.

In accordance with one embodiment of the present invention, the request for multimedia content is triggered by the turn of a page of the sensor enabled medium. The multimedia content manifested to an end-user can be evoked from at least one of a local multimedia device and a remote multimedia device. For example, the request for the multimedia content invokes forward-content-requests from a service provider. The multimedia content can sustain a buffer of local multimedia content sufficient to exceed the rate at which multimedia content is being requested by the end-user.

In another aspect of the present invention, the substrate medium can be cellulose-based engineered and manufactured with regard to physical, chemical, and electronic characteristics that include, and not limited to, pore dimensions, fiber density, fiber alignment, fiber dimensions, electrical charge, dopants, surface texture, polarization to various parts of the electromagnetic spectrum, physical layering, and paper chemistry.

In another aspect of the present invention, the substrate medium on which content is printed can be selectively infused with passive and/or active devices that include RFID devices/tags, to yield the functional equivalent of a watermark that is machine readable.

In another aspect of the present invention, the substrate medium on which content is printed, can be selectively attached and/or infused with machine readable RFID sensors/tags specific to content.

It should be appreciated that the present invention can be implemented and utilized in various ways, including but not limited to analog works, as a process, an apparatus, a system, a device, a method of applications now known and later developed.

### BRIEF DESCRIPTION OF THE DRAWINGS

FIG. 1 shows a block diagram of a multimedia content management system, in accordance with one embodiment of the present invention.

FIG. 2 shows a diagram of a binder coupled to a sensor enabled hardcopy document and sensor detection electronics and logic, and multimedia content, in accordance with another embodiment of the present invention.

### DETAILED DESCRIPTION OF DRAWINGS

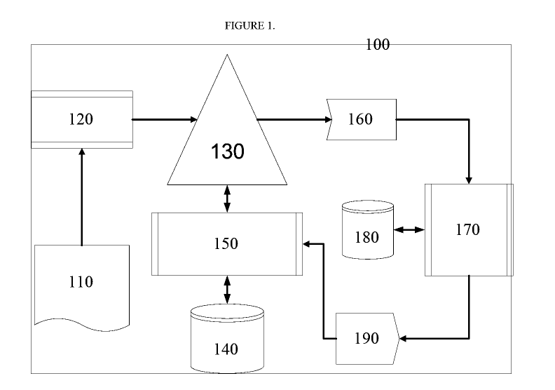

FIG. 1 shows a multimedia content management system 100, in accordance with one embodiment of the present invention. The system 100 represents the logical relationship between respective sub-system components, and the anticipated flow of synchronous and asynchronous transactions that can propagate amongst the sub-system components, and over a network. Client sub-system components, described further below, are anticipated to be local to the end-user. Server and data storage sub-system components, described further below, are anticipated to be remote to the end-user, with multimedia content accessed via network communications that may include the Internet.

The system 100 includes a sensor-enabled medium 110 coupled to sensor detection infrastructure for interacting with the sensor-enabled medium 110. The sensor-enabled medium 110 can be any medium coupled to a sensor, a transponder and/or RFID tags with an antenna. The medium can be any physical medium, such as, but not limited to a cellulose-based medium, paper, and printed medium. In one embodiment, the medium facilitates insertion of the sensor into a lattice matrix of the medium. In one embodiment, the sensor-enabled hardcopy content 110 is coupled to a binder.

The sensor detection infrastructure can include electronics 120 and a logic controller 130. The electronics 120 can be any sensor detection circuitry, such as an RFID reader, to support sensor detection from the sensor-enabled medium 110. The logic controller, which is coupled to the electronics 120, evokes multimedia content to be manifested to an end-user (on the client side). For example, when a media content request is transmitted from the sensor-enabled content 110 to the electronics 120, the logic controller 130 determines whether the request is local or remote and obtains the requested media content from, thus interactively augmenting the sensor-enabled medium 110 with the media content. In the above example, the media content request can be triggered simply by a turn of a page in a book.

Still referring to FIG. 1, if the request from the sensor-enabled medium 110 is local, the logic controller 130, after receiving the request, evokes local content 140 via any docked display and/or play device or devices 150. The devices can be any electronic or portable electronic devices, such as, but not limited to, smart phones, cell phones, multimedia players, Wi-Fi, and WiMax. The devices 150 can be coupled to docking connectors. Alternatively, if the request from the sensor-enabled medium 110 is a remote request 160, not local, the logic controller 130 evokes remote content 180 via a multimedia content service provider 170 through any network communications. Authentication, validation, billing, service, and support can be handled by the service provider 170. When the remote content 180 is obtained, the service provider 170 transmits the remote content 180 back to the end-user through a remote server 190 which evokes and delivers the remote content 180.

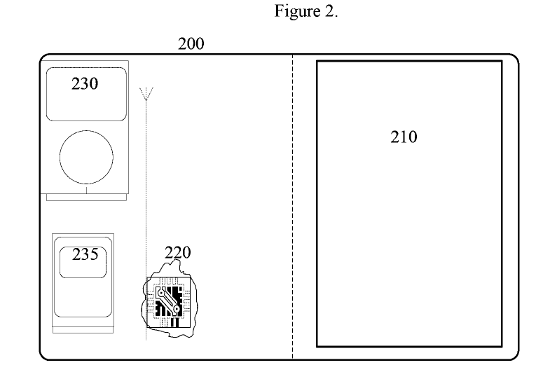

FIG. 2 shows a diagram of a binder 200 coupled to a sensor enabled hardcopy document 210 and sensor detection infrastructure 220, and multimedia devices 230 and 235, in accordance with another embodiment of the present invention. The hardcopy document 210 can be any physical medium, such as a book, paper, and/or hardcopy medium. In the FIG. 2, the hardcopy document can include at least one of: RFID tags, transponders, and sensors. The sensor detection infrastructure 220 includes electronic circuitry and a logic controller. The sensor detection infrastructure 220 can include an RFID reader or any electronic circuitry for interacting with the sensor enabled document 210 and for accepting requests. The binder 200 can also include local multimedia devices 230 and 235 for augmenting, say, a user's reading experience with multimedia content, enabling the coordination and synchrony of auditory and/or visual stimuli. The auditory and/or visual stimuli can include narration, animation, video, music and print media. As mentioned above, the sensor detection infrastructure 220 can also request remote multimedia content to be evoked and delivered to the end-user.

Still referring to FIG. 2, when a page of the sensor-enabled book 210 is turned by a user, the turn of the page triggers a request for content to the sensor detection infrastructure 220 as a result of the short-range interaction between the sensor-enabled book 210 and the RFID reader of the sensor detection infrastructure 220. The logic or logic controller of the sensor detection infrastructure 220 determines if the content request is local or remote and obtains the requested media content for the user.

The RFID tags (or sensors) can be coded to a prescribed protocol so as to be translated into a specific electronic request for content to be evoked that is topically associated with the printed material 210 being read. Evoked content may be local to the binder 200, or remote from the binder 200.

The present invention integrates proven “play and display” and wireless communications devices. The present invention interoperates with sensor-enabled books and documents. The present invention leverages connectivity to multimedia content managing serves via wireless service provider networks. The present invention can enable dynamic distribution and update of, for example, class lectures synchronized with texts and study guides printed on sensor-enabled paper. Users, such as students, can experience improved learning when their reading is accompanied with narration, music, and/or video clips.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

1. A multimedia content management system, comprising:
a. a sensor enabled medium;
b. a sensor detection infrastructure for interacting with the sensor enabled medium, such that when a media content request is transmitted from the medium to the detection infrastructure, a logic controller coupled to the detection infrastructure determines whether the request is local or remote and obtains the requested media content, thus interactively augmenting the medium with the media content.

2. The system of claim 1 wherein the medium is paper.

3. The system of claim 1 wherein the sensor enabled medium comprises an RFID device and antennae coupled to the medium.

4. The system of claim 3 wherein the RFID device is one of a RFID tag and a transponder.

5. (canceled)

6. The system of claim 3 wherein the medium facilitates insertion of sensor technology into a lattice matrix of the medium.

7. The system of claim 3 wherein the medium enhances the radio frequency and/or electromagnetic spectrum performance and antennae performance of the RFID device.

8. The system of claim 1 wherein one of nano-scale and micro-scale particles are selectively deposited on and/or in a substrate of the medium.

9. The system of claim 8 wherein the particles are at least one of the following: zinc, copper, silver, gold, and alloy.

10. The system of claim 8 wherein sufficient RF resonant performance, or Q, is induced by the particles to enable the associated RF infrastructure to interact with passive sensors/tags and/or RFID transponders.

11. The system of claim 1 inkjet technology is used to facilitate development of the sensor enabled medium.

12. The system of claim 1 wherein the sensor detection infrastructure is coupled to a binder, wherein the binder is also coupled to the medium.

13. The system of claim 12 wherein the binder includes electronic circuitry to support the detection infrastructure.

14. The system of claim 13 wherein the RFID reader technology and sensors are incorporated into operation of the binder.

15. The system of claim 14 wherein the binder includes docking connectors into which is docked portable multimedia devices.

16. The system of claim 15 wherein the portable multimedia devices include at least one of the following: smart phones, cell phones, Wi-Fi, WiMax, and multimedia players.

17. The system of claim 1 wherein the request for multimedia content is triggered by the turn of a page of the sensor enabled medium.

18. The system of claim 1 wherein the multimedia content manifested to an end-user is evoked from at least one of a local multimedia device and a remote multimedia device.

19. The system of claim 18 wherein the request for the multimedia content invokes forward-content-requests from a service provider.

20. The system of claim 19 wherein the multimedia content sustains a buffer of local multimedia content sufficient to exceed the rate at which multimedia content is being requested by the end-user.

21. A method of managing multimedia content and access to content, comprising:
a. Evoking a multimedia content request from a sensor enabled medium;
b. Determining whether the request is local or remote; and
c. Augmenting the medium with the requested media content.
